(19) United States
(12) Patent Application Publication
(10) Pub. No.: US 2023/0196507 A1
(43) Pub. Date: Jun. 22, 2023

(54) DEVICE, METHOD AND PROGRAM FOR PROCESSING IMAGE

(71) Applicants: Haining ESWIN IC Design Co., Ltd., Haining (CN); Beijing ESWIN Computing Technology Co., Ltd., Beijing (CN)

(72) Inventors: Benchuan HU, Haining (CN); Bo ZHAO, Haining (CN)

(21) Appl. No.: 18/066,895

(22) Filed: Dec. 15, 2022

(30) Foreign Application Priority Data
Dec. 16, 2021 (CN) 202111541158.6

(51) Int. Cl. G06T 3/40

(52) U.S. Cl. CPC G06T 3/4023

(57) ABSTRACT

The present disclosure provides a device, a method and a program for processing an image. The device for processing the image includes: a data processing unit configured to obtain an original image, to downsample the original image at a first sub-rate to obtain a transitional image, and to downsample the transitional image at a second sub-rate to obtain a target image. The first sub-rate and the second sub-rate are obtained by dividing a downsampling rate of the original image, and a product of the first sub-rate and the second sub-rate is equal to the downsampling rate. The device, the method and the program for processing the image not only can better retain texture information of the original image in the process of downsampling the original image, but also can cause the change of detail textures in the image to be continuous in the process of continuous change of the sampling rate, thereby improving a display effect of an filtered image.

### CROSSREFERENCE TO RELATED APPLICATION

This application claims priority to Chinese Patent Application No. 202111541158.6 titled “DEVICE, METHOD AND PROGRAM FOR PROCESSING IMAGE” and filed 2021-12-16 to the State Patent Intellectual Property Office on the entire contents of which are incorporated herein by reference.

### TECHNICAL FIELD

The present disclosure relates to the field of image display technology, and more particularly, to a device, a method and a program for processing an image.

### BACKGROUND

With continuous development of image display technologies, image content has more and more diversified display forms, such as picture-in-picture. The picture-in-picture means that a frame of a bigger image and a frame of a smaller image are overlapped with each other, such that two frame signals may be presented simultaneously. The bigger image has an original resolution, while the smaller image needs to be downsampled at the original resolution to obtain a low-resolution image, and then the low-resolution image is overlapped on the bigger image and is displayed.

At present, there are mainly two common methods for downsampling an image as follows: a nearest neighbor interpolation (NNI) downsampling method, and a linear downsampling method such as a bilinear interpolation downsampling method and a bi-cubic interpolation downsampling method.

However, the above two downsampling methods cause serious texture loss of the image. In some scenes, clear texture information in the image may become blurred or even may be lost, which may reduce a display effect of the image downsampled.

### SUMMARY

An objective of embodiments of the present disclosure is to provide a device, a method and a program for processing an image, such that more texture information of an image may be retained during downsampling.

To solve the above technical problems, the embodiments of the present disclosure provide the following technical solutions.

A first aspect of the present disclosure provides a device for processing an image. The device includes: a data processing unit configured to obtain an original image, to downsample the original image at a first sub-rate to obtain a transitional image, and to downsample the transitional image at a second sub-rate to obtain a target image. The first sub-rate and the second sub-rate are obtained by dividing a downsampling rate of the original image, and a product of the first sub-rate and the second sub-rate is equal to the downsampling rate.

A second aspect of the present disclosure provides a method for processing an image, performed by a device for processing an image. The method includes: obtaining an original image, downsampling the original image at a first sub-rate to obtain a transitional image, and downsampling the transitional image at a second sub-rate to obtain a target image. The first sub-rate and the second sub-rate are obtained by dividing a downsampling rate of the original image, and a product of the first sub-rate and the second sub-rate is equal to the downsampling rate.

A third aspect of the present disclosure provides a program for executing image processing by using a device for processing an image. The device for processing the image includes a data processing unit, and the program causes the data processing unit to: obtain an original image, downsample the original image at a first sub-rate to obtain a transitional image, and downsample the transitional image at a second sub-rate to obtain a target image. The first sub-rate and the second sub-rate are obtained by dividing a downsampling rate of the original image, and a product of the first sub-rate and the second sub-rate is equal to the downsampling rate.

Compared with the prior art, after the original image and the downsampling rate are obtained by the data processing unit in the device for processing the image, the device for processing the image provided according to the first aspect of the present disclosure first downsamples the original image at the first sub-rate to obtain the transitional image, and then downsamples the transitional image at the second sub-rate to obtain the target image, where the first sub-rate and the second sub-rate are obtained by dividing the downsampling rate of the original image, and the product of the first sub-rate and the second sub-rate is equal to the downsampling rate. In this way, the target image is obtained after the original image is downsampled at twice. Compared to the process of directly processing the original image into the target image by means of once downsampling, in the process of twice downsampling, the original image is first processed into the transitional image, and then the transitional image is processed into the target image. In the process of first downsampling, all pixels in an image can be used as more as possible, such that various information in the image, including texture information, is retained. Next, the finally required target image is obtained by means of second downsampling. In this way, the device for processing the image not only can better retain the texture information of the original image in the process of downsampling the original image, but also can cause the change of detail textures in the image to be continuous in the process of continuous change of the sampling rate, thereby improving a display effect of an filtered image.

The method for processing the image, performed by the device for processing the image provided according to the second aspect of the present disclosure, and the program for executing image processing by using the device for processing the image provided according to the third aspect of the present disclosure have the same or similar beneficial effects as or to the device for processing the image provided according to the first aspect of the present disclosure.

### BRIEF DESCRIPTION OF THE DRAWINGS

The above and other objectives, features and advantages of exemplary embodiments of the present disclosure will be readily understood by reading the detailed description below with reference to the accompanying drawings. In the accompanying drawings, several embodiments of the present disclosure are illustrated by way of example and not limitation, with like or corresponding reference numerals designating like or corresponding portions, in which:

FIG. 1 is a schematic structural diagram I of a device for processing an image according to an embodiment of the present disclosure;

FIG. 2 is a schematic flowchart I of a method for processing an image, executed by a device for processing an image according to an embodiment of the present disclosure;

FIG. 3 is a schematic structural diagram II of a device for processing an image according to an embodiment of the present disclosure;

FIG. 4 is a schematic flowchart II of a method for processing an image, executed by a device for processing an image according to an embodiment of the present disclosure;

FIG. 5 is a schematic diagram showing number of horizontal pixels or vertical pixels of a first pixel block according to an embodiment of the present disclosure;

FIG. 6 is a schematic diagram showing a horizontal weight and a vertical weight corresponding to each pixel in the first pixel block according to an embodiment of the present disclosure; and

FIG. 7 is a schematic diagram showing hardware configuration of a device for processing an image according to an embodiment of the present disclosure.

### DETAILED DESCRIPTION

Exemplary embodiments of the present disclosure will be described in detail below with reference to the accompanying drawings. Although the exemplary embodiments of the present disclosure are illustrated in the accompanying drawings, it should be understood that the present disclosure may be embodied in various forms and should not be limited by the embodiments set forth herein. Rather, these embodiments are provided such that the present disclosure can be understood thoroughly and the scope of the present disclosure can be fully conveyed to those skilled in the art.

It should be noted that unless otherwise stated, technical or scientific terms used herein shall have a general meaning as commonly understood by those skilled in the art to which the present disclosure pertains.

At present, when there is a need to reduce a resolution of an image, the resolution of the image is reduced from an original resolution to a target resolution by means of nearest neighbor downsampling, linear interpolation downsampling and the like in general.

However, when the resolution of the image is reduced by means of the above-mentioned downsampling manners, texture information in the image may be seriously lost, which may reduce a display effect of a downsampled image.

After in-depth study, it is found by the inventor that a root cause of the serious loss of the texture information of the image due to the downsampling of the image by means of the nearest neighbor downsampling, the linear interpolation downsampling and the like is as below. When the resolution of the image is directly reduced from the original resolution to the target resolution at one go, some pixels in the image may not be used during downsampling of the image. Thus, some information in the original image is missing in the downsampled image, such that the texture information of the downsampled image is seriously lost.

In view of this, an embodiment of the present disclosure provides a device for processing an image. When the image needs to be downsampled by a data processing unit in the device for processing the image, the resolution of the image is not directly reduced from the original resolution to the target resolution at one go, but is reduced from the original resolution to an intermediate resolution first and then is reduced from the intermediate resolution to the target resolution. Because the resolution of the image is reduced from the original resolution to the intermediate resolution higher than the target resolution, all pixels in the image can be used during first downsampling, such that various information in the image, including the texture information, is retained. Next, the resolution of the image reaches the final target resolution by means of second downsampling. As can be seen, when the resolution of the image needs to be reduced, two-stage filtering is used. That is, the resolution of the image is reduced from the original resolution to the intermediate resolution first and then is reduced to the target resolution, which can better retain the texture information of the image during downsampling of the image, thereby improving the display effect of a filtered image.

In practical applications, the device for processing the image provided by the embodiment of the present disclosure may be applied to various scenes where the resolution of the image needs to be reduced. For example, the scenes may be scenes where picture-in-picture needs to be used, such as televisions, video recording, monitoring, demonstration devices, and remote videos, etc. For another example, the scene may be a scene where the original resolution of the image is higher and a display device cannot support such high-resolution image. The specific usage scene of the device for processing the image provided by the embodiment of the present disclosure is not limited herein.

Next, a specific executive process inside the device for processing the image provided by the embodiment of the present disclosure is described in detail.

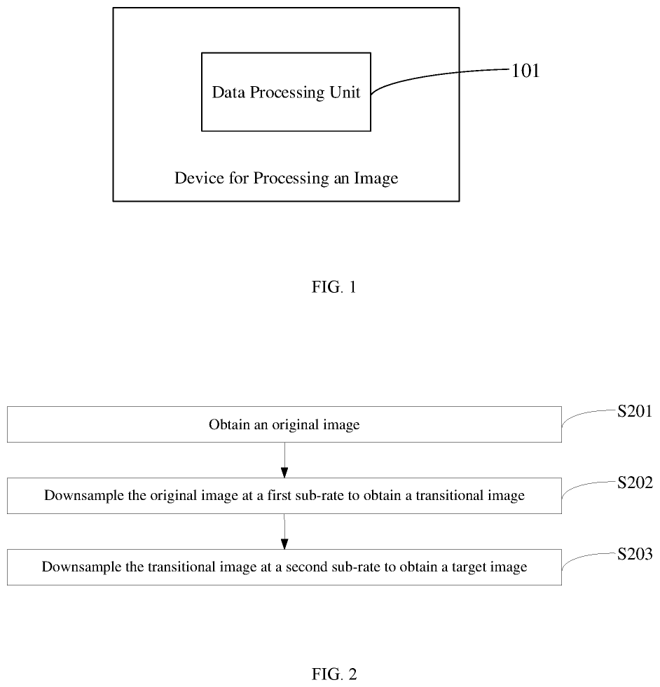

FIG. 1 is a schematic structural diagram I of a device for processing an image according to an embodiment of the present disclosure. Referring to FIG. 1, the device for processing the image may include a data processing unit 101. The original image can be downsampled in two steps by the data processing unit 101 to finally obtain a target image including more texture information in the original image.

That is, the data processing unit in the device for processing the image is configured to obtain an original image, to downsample the original image at a first sub-rate to obtain a transitional image, and to downsample the transitional image at a second sub-rate to obtain the target image. The first sub-rate and the second sub-rate are obtained by dividing a downsampling rate of the original image, and a product of the first sub-rate and the second sub-rate is equal to the downsampling rate.

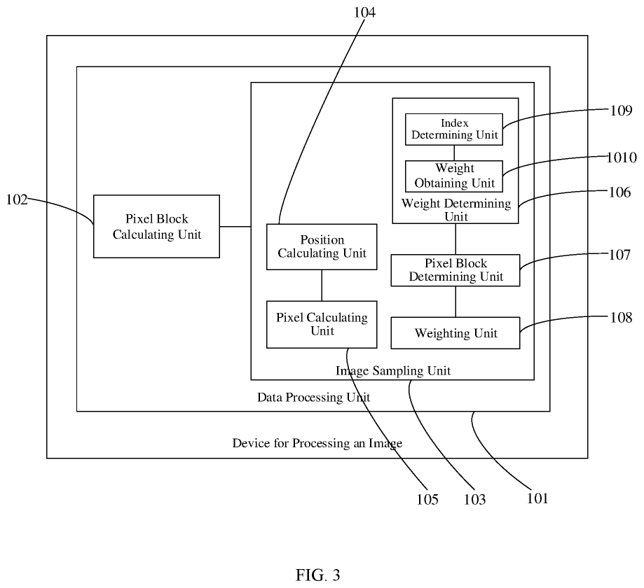

FIG. 2 is a schematic flowchart I of a method for processing an image, executed by the device for processing the image according to an embodiment of the present disclosure. Referring to FIG. 2, the method for processing the image may include following steps.

S201: obtaining an original image.

The original image is an image that needs to be processed to reduce its resolution.

While the original image is obtained, a downsampling rate corresponding to the original image needs to be known. That is, it is needed to know what size of an image is the original image specifically processed into.

The downsampling rate is a specific rate needed to downsample the image to reduce the resolution of the image from the original resolution to the target resolution.

For example, assuming that the resolution of the original image is 256*256, the resolution of the image needs to be reduced to 32*32 according to an actual need. So, the downsampling rate here is ⅛.

It should be noted here that the image is downsampled. That is, the resolution of the image is reduced. Therefore, the downsampling rate here is a value less than 1 and greater than 0. However, the specific value of the downsampling rate needs to be determined according to actual reduction of the image, and is not limited here.

To avoid losing more texture information of the image during downsampling, the image may be downsampled at twice. During each downsampling, rates of this downsampling, i.e., the first sub-rate or the second sub-rate need to be known.

A product of the first sub-rate and the second sub-rate is equal to the downsampling rate. The downsampling rate is divided into the first sub-rate and the second sub-rate in a form of the product, this is because the image exists in the form of multiples during zoom-in or zoom-out. Therefore, when once downsampling process is divided into twice downsampling processes, it is needed to ensure the product of the rates used in the twice downsampling processes to be equal to the rate in the previous once downsampling process.

After the downsampling rate is obtained, the downsampling rate may be directly divided to be in the form of multiplication of two sub-rates, thus obtaining the first sub-rate and the second sub-rate. Of course, it is also acceptable to determine the first sub-rate according to some preset rules and then divide the downsampling rate by the first sub-rate to obtain the second sub-rate. Specific ways of obtaining the first sub-rate and the second sub-rate are not limited here.

Because the downsampling rate is a positive number less than 1 and the original image is downsampled at twice, both the first sub-rate and the second sub-rate are positive numbers less than 1. Moreover, both the first sub-rate and the second sub-rate are greater than the downsampling rate. That is, expressed in mathematical formulas: r<1, r=r1*r2, r<r1<1, and r<r2<1, where r denotes the downsampling rate, r1 denotes the first sub-rate, and r2 denotes the second sub-rate. In this way, the original image may not be zoomed out too much in the once downsampling process, thus ensuring that the texture information of the original image is retained.

With continued reference to the above example, assuming that the downsampling rate is ⅛, ⅛ may be divided to be in the form of ½×¼. In this way, the first sub-rate and the second sub-rate are respectively ½ and ¼. Of course, ⅛ may also be divided to be in a form of ⅓×⅜. In this way, the first sub-rate and the second sub-rate are respectively ⅓ and ⅜. Of course, ⅛ may also be divided to be in the form of multiplication of other two fractions, as long as a product of the two fractions is equal to the downsampling rate. After the downsampling rate is determined, specific values of the first sub-rate and the second sub-rate are not limited here.

S202: downsampling the original image at a first sub-rate to obtain a transitional image.

After the first downsampling rate, i.e., the first sub-rate is determined, the original image may be downsampled according to the first sub-rate, and a result obtained after the downsampling is the transitional image having an intermediate resolution.

S203: downsampling the transitional image at a second sub-rate to obtain a target image.

After the second downsampling rate, i.e., the second sub-rate is determined, the transitional image may be downsampled according to the second sub-rate, and a result obtained after the downsampling is the target image having the target resolution.

With continued reference to the above example, assuming that the resolution of the original image is 256*256, the first sub-rate is ½, and the second sub-rate is ¼. After the first downsampling, that is, after the step S203, the resolution of the original image is reduced from 256*256 to 128*128 on the basis of the first sub-rate ½. In this way, the transitional image is obtained. Next, after the second downsampling, that is, after the step S204, the resolution of the transitional image is reduced from 128*128 to 32*32 on the basis of the second sub-rate ¼. In this way, the finally required target image with the resolution of 32*32 is obtained.

The specific way of downsampling may be bilinear interpolation downsampling, bi-cubic interpolation downsampling, and so on. The specific way of downsampling used in the embodiment of the present disclosure is not limited here.

Finally, it should be noted that a rate value in the downsampling rate is a lower rate. For example, the image is zoomed out by eight times. However, if the rate value of the downsampling rate is a higher rate, for example, if the image is zoomed out by eight hundred times, it is meaningless to retain the texture information of the image. This is because any detail texture information is meaningless when a zoom-out factor of the image is higher. Therefore, in the embodiment of the present disclosure, the downsampling is performed at a low rate, thus the texture information in the original image is retained. A specific threshold of the low rate is not specifically limited in the embodiment of the present disclosure.

As can be seen from the above contents, after the original image and the downsampling rate are obtained by the data processing unit in the device for processing the image, the device for processing the image provided by the embodiment of the present disclosure first downsamples the original image at the first sub-rate to obtain the transitional image, and then downsamples the transitional image at the second sub-rate to obtain the target image, where the first sub-rate and the second sub-rate are obtained by dividing the downsampling rate of the original image, and the product of the first sub-rate and the second sub-rate is equal to the downsampling rate. In this way, the target image is obtained after the original image is downsampled at twice. Compared to the process of directly processing the original image into the target image by means of once downsampling, in the process of twice downsampling, the original image is first processed into the transitional image, and then the transitional image is processed into the target image. In the process of first downsampling, all pixels in an image can be used as more as possible, such that various information in the image, including texture information, is retained. Next, the finally required target image is obtained by means of second downsampling. In this way, the device for processing the image not only can better retain the texture information of the original image in the process of downsampling the original image, but also can cause the change of detail textures in the image to be continuous in the process of continuous change of the sampling rate, thereby improving a display effect of an filtered image.

Further, as a refinement and expansion of the device shown in FIG. 1, an embodiment of the present disclosure also provides an device for processing an image. FIG. 3 is a schematic structural diagram II of a device for processing an image according to an embodiment of the present disclosure. Referring to FIG. 3, the device for processing the image may include a data processing unit 101. The data processing unit 101 can obtain an original image, downsample the original image at a first sub-rate to obtain a transitional image, and downsample the transitional image at a second sub-rate to obtain a target image.

The data processing unit 101 may include a pixel block calculating unit 102 and an image sampling unit 103. The pixel block calculating unit 102 can determine number of horizontal pixels or vertical pixels of a first pixel block configured to be downsampled in the original image according to the first sub-rate, where the number of the horizontal pixels or the vertical pixels of the first pixel block is greater than or equal to the reciprocal of the first sub-rate. The image sampling unit 103 can downsample the original image based on the first sub-rate and the number of the horizontal pixels or the vertical pixels of the first pixel block to obtain the transitional image.

The image sampling unit 103 may include a position calculating unit 104 and a pixel calculating unit 105. The position calculating unit 104 can determine, according to a position of each transitional pixel in the transitional image, the first sub-rate and the number of the horizontal pixels or the vertical pixels of the first pixel block, a position of an original pixel block, in the original image, corresponding to the each transitional pixel configured to be downsampled in the original image. The pixel calculating unit 105 can calculate a pixel value of the each transitional pixel in the transitional image based on the position of the original pixel block, in the original image, corresponding to the each transitional pixel and the number of the horizontal pixels or the vertical pixels of the first pixel block, to obtain the transitional image.

The image sampling unit 103 may also include a weight determining unit 106, a pixel block determining unit 107, and a weighting unit 108. The weight determining unit 106 can determine a weight corresponding to each pixel in the first pixel block. The pixel block determining unit 107 can determine each original pixel block in the original image according to the position of the original pixel block, in the transitional image, corresponding to the each transitional pixel in the original image and the number of the horizontal pixels or the vertical pixels of the first pixel block. The weighting unit 108 can correspondingly multiply the pixel value of each pixel in each original pixel block by the weight corresponding to the each pixel in the first pixel block, and add corresponding multiplied results to obtain a pixel value of the each transitional pixel in the transitional image, to obtain the transitional image.

The weight determining unit 106 may include an index determining unit 109 and a weight obtaining unit 1010. The index determining unit 109 can determine, according to the position of the each transitional pixel in the transitional image, the first sub-rate and a length of a first preset table, an index of the each transitional pixel in the first preset table, where the first preset table stores a corresponding relationship between each index and a corresponding weight. The weight obtaining unit 1010 can determine the weight corresponding to each pixel in the first pixel block from the first preset table according to the index of each transitional pixel in the first preset table.

Furthermore, the position of each transitional pixel in the transitional image includes an abscissa and an ordinate, and the weight corresponding to each pixel in the first pixel block includes a horizontal weight and a vertical weight. Accordingly, the weighting unit 108 specifically can correspondingly multiply the pixel value of the each pixel in each original pixel block by the horizontal weight and the vertical weight corresponding to the each pixel in the first pixel block, and add corresponding multiplied results to obtain the pixel value of the each transitional pixel in the transitional image.

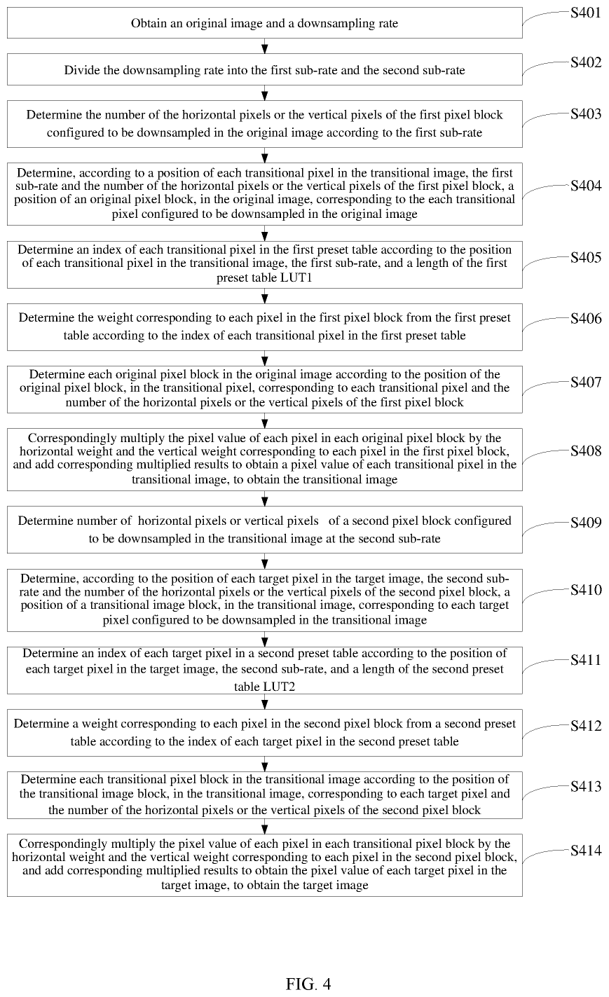

Further, as a refinement and extension of the method shown in FIG. 2, the specific execution process of the device shown in FIG. 3 is described in detail. FIG. 4 is a schematic flowchart II of a method for processing an image, executed by the device for processing the image according to an embodiment of the present disclosure. Referring to FIG. 4, the method for processing the image may include following steps.

S401: obtaining an original image and a downsampling rate.

The specific implementation of step S401 is the same as that of the above step S201, and thus detailed descriptions thereof are omitted here.

S402: dividing the downsampling rate into the first sub-rate and the second sub-rate.

In the process of dividing the downsampling rate into the first sub-rate and the second sub-rate, to ensure that the texture information exists in the subsequent downsampling process and more texture information can be retained, the first sub-rate and the second sub-rate need to follow at least one of the following two rules:

Rule I: both

$$\frac{1}{r 1} and \frac{1}{r 2}$$

are not integers; and

Rule II: r1 is greater than r2;

where r denotes the downsampling rate, r1 denotes the first sub-rate, and r2 denotes the second sub-rate.

Based on the Rule I, it can be ensured that textures are not lost in the downsampling process. Based on the Rule II, it can be ensured that more textures are retained in the downsampling process.

It should be noted here that in the Rule II, r1 may be set to be as great as possible. Because r<1 and r=r1*r2, r<r1<1. That is, r1 may be closer to 1. The specific value of r1 is not limited here.

The specific values of the first sub-rate and the second sub-rate under different downsampling rates are given in Table 1 below. Of course, this is not intended to limit a case where the values of the first sub-rate and the second sub-rate can only be taken according to the first sub-rate and the second sub-rate given in Table 1 under a sampling rate. The specific values given here are only values for better retaining the texture information during downsampling after a lot of practice.

TABLE 1
Corresponding relationships between the downsampling rates and the
corresponding first and second sub-rates

| Downsampling rate (r) | First sub-rate (r1) | Second sub-rate (r2) |
|---|---|---|
| 1/2 | 3/4 | 2/3 |
| 1/3 | 5/6 | 2/5 |
| 1/4 | 7/8 | 2/7 |
| 1/5 | 7/10 | 2/7 |
| 1/6 | 7/12 | 2/7 |
| 1/7 | 9/14 | 2/9 |
| 1/8 | 9/16 | 2/9 |

S403: determining the number of the horizontal pixels or the vertical pixels of the first pixel block configured to be downsampled in the original image according to the first sub-rate.

When the original image needs to be downsampled for the first time at the first sub-rate, first it is needed to determine how large area of pixels in the original image are aggregated to obtain one pixel in the transitional image, where this area is the first pixel block.

The number of the horizontal pixels or the vertical pixels of the first pixel block is greater than or equal to a reciprocal of the first sub-rate. In this way, it can be ensured that every pixel in the original image can be used in the process of processing the original image into the transitional image, thus better retaining the texture information in the original image.

FIG. 5 is a schematic diagram showing the number of the horizontal pixels or the vertical pixels of the first pixel block according to an embodiment of the present disclosure. Referring to FIG. 3, assuming that a size of the original image is 10*10 and the first sub-rate is ½, the minimum number of the horizontal pixels or the vertical pixels of the first pixel block is 2*2. In this way, it can be ensured that every pixel in the original image can be used, thus ensuring that the texture information of the image can be retained in the downsampling process. Of course, the minimum number of the horizontal pixels or the vertical pixels of the first pixel block may be 4*4. The specific number of the horizontal pixels or the vertical pixels of the first pixel block is not limited here. However, generally the number of the horizontal pixels or the vertical pixels of the first pixel block is n*n, where n is generally an even number. In this way, it can be ensured that a value of each pixel in the transitional image is more balanced during downsampling.

S404: determining, according to a position of each transitional pixel in the transitional image, the first sub-rate and the number of the horizontal pixels or the vertical pixels of the first pixel block, a position of an original pixel block, in the original image, corresponding to the each transitional pixel configured to be downsampled in the original image.

That is, for each pixel in the transitional image, it is needed to respectively determine, according to the position of each transitional pixel in the transitional image, the first sub-rate and the number of the horizontal pixels or the vertical pixels of the first pixel block, the position of the original pixel block, in the original image, configured to be downsampled in the original image.

Taking determination of the position of the original pixel block in the original image, corresponding to a certain pixel in the transitional image, in the original image as an example, specifically, step S404 may be performed by the following Formulas (1) and (2):

x_src0=[x_dst0/r1]−(n/2−1) Formula (1)

y_src0=[y_dst0/r1]−(n/2−1) Formula (2)

where x_dst0 and y_dst0 denote coordinates of any one pixel in the transitional image, r1 denotes the first sub-rate, n denotes the number of the horizontal pixels or the vertical pixels in the first pixel block, and x_src0 and y_src0 denote coordinates of a first pixel in the original pixel block in the original image.

Of course, it is also acceptable to determine, according to the position of each transitional pixel in the transitional image, the first sub-rate and the number of the horizontal pixels or the vertical pixels of the first pixel block, the position of the original pixel block, in the original image, corresponding to each transitional pixel configured to be downsampled in the original image by other ways. For example, coefficients are added in the above Formulas (1) and (2), or the Formulas (1) and (2) are adjusted. The specific way thereof is not limited here.

After step S404, that is, after the coordinates of all the pixels in the original pixel block corresponding to each transitional pixel configured to be downsampled in the original image are determined, a weight corresponding to each pixel in the first pixel block needs to be determined, such that all original pixel blocks corresponding to each transitional pixel are interpolated in the original image. In this way, the calculated pixel value can be more accurate, thus accuracy of image processing is improved.

The weight corresponding to each pixel in the first pixel block may be stored in the first preset table in advance and is obtained by search. The weight corresponding to each pixel in the first pixel block may also be obtained in combination with an existing calculation formula. No matter by the preset table or by the calculation formula, it may be generated according to a nearest neighbor formula, a bilinear formula, a bi-cubic formula, a polynomial formula or by experience.

In a specific implementation process, the weight corresponding to each pixel in the first pixel block may be one weight value corresponding to one pixel, or one weight value corresponding to one pixel in a horizontal direction and one weight value corresponding to one pixel in a vertical direction, and then the weight values in the two directions are multiplied to obtain the weight of the pixel. The specific existence form of the weight is not limited here. When the weight exists in the latter form described above, specifically, the following step S405 needs to be performed.

S405: determining an index of each transitional pixel in the first preset table according to the position of each transitional pixel in the transitional image, the first sub-rate, and a length of the first preset table LUT1.

The first preset table stores corresponding relationships between indexes and corresponding weights.

Taking determination of the corresponding weight of a certain pixel in the transitional image, in the first preset table as an example, specifically, step S405 may be performed by the following Formulas (3) and (4):

phase1_x=└x_dst0×len/r1┘−└x_dst0/r1┘×len Formula (3)

phase1_y=└y_dst0×len/r1┘−└y_dst0/r1┘×len Formula (4)

where x_dst0 and y_dst0 denote coordinates of any one pixel in the transitional image, len denotes the length of the first preset table, r1 denotes the first sub-rate, phase1_x and phase1_y denote indexes of pixels in a first row and a first column of the transitional image, in the first preset table, and └ ┘ denotes rounding down.

Because the transitional pixel has an abscissa and an ordinate, the index calculated by the above Formulas (3) and (4) includes a horizontal index and a vertical index.

Of course, it is also acceptable to determine, according to the position of each transitional pixel in the transitional image, the first sub-rate and the length of the first preset table, the index of each transitional pixel in the first preset table by other ways. For example, coefficients are added in the above Formulas (3) and (4), or the Formulas (3) and (4) are adjusted. The specific way thereof is not limited here.

S406: determining the weight corresponding to each pixel in the first pixel block from the first preset table according to the index of each transitional pixel in the first preset table.

After the indexes, i.e., the horizontal index and the vertical index of each transitional pixel in the corresponding two directions, in the first preset table are obtained, corresponding horizontal weight and vertical weight of each pixel can be searched out from the first preset table. Next, in the original image, the horizontal weight and the vertical weight corresponding to each pixel in the first pixel block can be obtained.

That is, corresponding two parameters params0_x and params0_y can be searched out from the first preset table according to phase1_x and phase1_y obtained by the above Formulas (3) and (4). The parameters params0_x and params0_y correspond to the horizontal weight and the vertical weight corresponding to each pixel in the first pixel block.

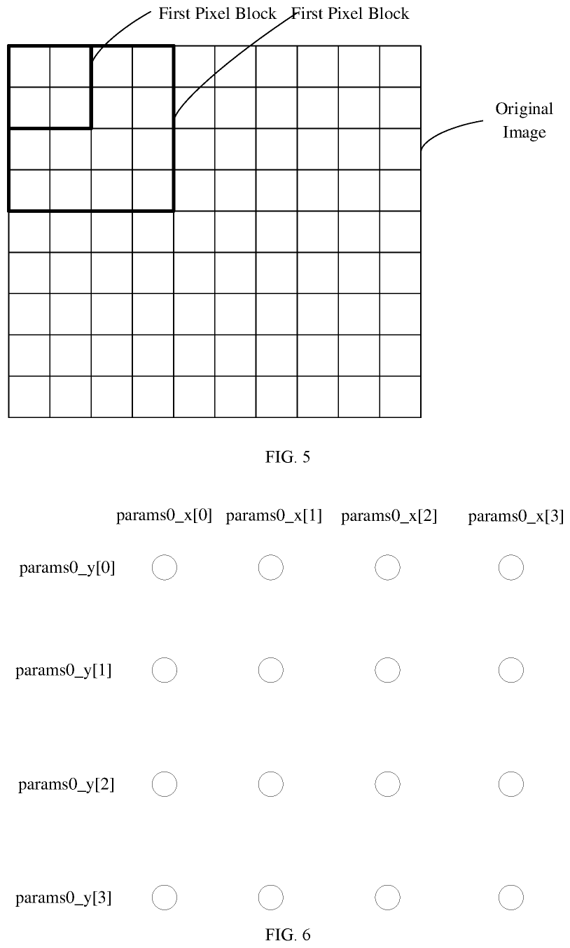

FIG. 6 is a schematic diagram showing the horizontal weight and the vertical weight corresponding to each pixel in the first pixel block according to an embodiment of the present disclosure. Referring to FIG. 4, a certain pixel in the transitional image may correspond to 4*4 pixels in the original image. Correspondingly, a size of the first pixel block is 4*4. In this way, horizontal weights corresponding to each row of four pixels in the first pixel block are params0_x[0], params0_x[1], params0_x[2], and params0_x[3] respectively. Vertical weights corresponding to each column of four pixels in the first pixel block are params0_y[0], params0_y[1], params0_y[2], and params0_y[3] respectively. As can be seen, a weight of a zeroth pixel in the first pixel block is params0_x[0]*params0_y[0], and by analogy, a weight of a fifteenth pixel in the first pixel block is params0_x[3]*params0_y[3].

S407: determining each original pixel block in the original image according to the position of the original pixel block, in the transitional pixel, corresponding to the each transitional pixel and the number of the horizontal pixels or the vertical pixels of the first pixel block.

After the horizontal weight and the vertical weight corresponding to each pixel in the first pixel block are determined, to interpolate a pixel of a block in the original image by the weights to one pixel in the transitional image, it is also needed to determine a pixel region, i.e., each original pixel block needed to be interpolated in the original image, corresponding to each pixel in the transitional image.

For example, assuming that the original image of 256*256 needs to be transformed into the transitional image of 128*128, the size of the first image block is 4*4. For a zeroth pixel in the transitional image, the corresponding original pixel blocks in the original image are sixteen pixels including first four pixels in a first row, first four pixels in a second row, first four pixels in a third row, and first four pixels in a fourth row. In this way, the original image is divided into a plurality of original pixel blocks like this, and each original pixel block processed is each pixel in the transitional image.

For example, assuming that n=4, all pixel coordinates of a certain pixel in the transitional image, mapped to the original pixel block in the original image are these sixteen pixels (x_src0, y_src0), (x_src1, y_src0), (x_src2, y_src0), (x_src3, y_src0), . . . , (x_src0, y_src3), (x_src1, y_src3), (x_src2, y_src3), and (x_src3, y_src3). Next, pixel values of corresponding positions in the transitional image can be obtained by interpolating the sixteen pixels in combination with the horizontal weights and the vertical weights.

S408: correspondingly multiplying the pixel value of each pixel in each original pixel block by the horizontal weight and the vertical weight corresponding to the each pixel in the first pixel block, and adding corresponding multiplied results to obtain a pixel value of the each transitional pixel in the transitional image, to obtain the transitional image.

After the original pixel block, in the original image, corresponding to each pixel in the transitional image and the horizontal weight and the vertical weight of each pixel in the first pixel block are determined, for each original pixel block, the pixel value of each pixel in each original pixel block is correspondingly multiplied by the horizontal weight and the vertical weight corresponding to each pixel in the first pixel block, and the corresponding multiplied results are added. In this way, one pixel in the transitional image is obtained. By analogy, the pixel value of each transitional pixel in the transitional image is obtained by performing such calculation on each target pixel block.

Taking determination of a certain pixel in the transitional image as an example, specifically, step S408 may be performed by the following Formula (5):

$$Formula ( 5 )$$

$$\begin{matrix}val\_dst 0 ( x\_dst 0 \_ 0 , y\_dst 0 \_ 0 ) = \\ params 0 \_x [ 0 ] \times params 0 \_y [ 0 ] \times val\_src 0 ( x\_src 0 , y\_scr 0 ) + \\ params 0 \_x [ 1 ] \times params 0 \_y [ 0 ] \times val\_src 0 ( x\_src 1 , y\_scr 0 ) + \\ params 0 \_x [ 2 ] \times params 0 \_y [ 0 ] \times val\_src 0 ( x\_src 2 , y\_scr 0 ) + \\ … \\ params 0 \_x [ 2 ] \times params 0 \_y [ 3 ] \times val\_src 0 ( x\_src 2 , y\_scr 3 ) + \\ params 0 \_x [ 3 ] \times params 0 \_y [ 3 ] \times val\_src 0 ( x\_src 3 , y\_scr 3 )\end{matrix}$$

where val_dst0(x_dst0_0, y_dst0_0) denotes a pixel value of a pixel whose coordinate is (x_dst0_0, y_dst0_0) in the transitional image, val_src0(x_src0, y_src0) denotes a pixel value of a pixel whose coordinate is (x_src0, y_src0) in the original image, and params0_x[0] and params0_y[0] respectively denote weights corresponding to a first column of pixels and weights corresponding to a first row of pixels in the original image block, i.e., the horizontal weights corresponding to a first column of pixels and the vertical weights corresponding to a first row of pixels in the first pixel block.

In this way, the process of downsampling the original image at the first sub-rate to obtain the transitional image is completed. However, the process of downsampling the transitional image at the second sub-rate to obtain the target image is similar to the specific implementation of steps S403 to S408, and thus is merely briefly illustrated below, and reference is made to the above steps S403 to S408 for detailed process parameters.

S409: determining number of horizontal pixels or vertical pixels of a second pixel block configured to be downsampled in the transitional image at the second sub-rate.

Because the value of the second sub-rate is smaller than the value of the first sub-rate, the number of the horizontal pixels or the vertical pixels of the second pixel block is greater than the number of the horizontal pixels or the vertical pixels of the first pixel block. For example, the number n of the horizontal pixels or the vertical pixels of the first pixel block is equal to 4, and the number m of the horizontal pixels or the vertical pixels of the second pixel block is equal to 6.

S410: determining, according to the position of each target pixel in the target image, the second sub-rate and the number of the horizontal pixels or the vertical pixels of the second pixel block, a position of a transitional image block, in the transitional image, corresponding to each target pixel configured to be downsampled in the transitional image.

Taking determination of the position of the transitional image block in the transitional image, corresponding to a certain pixel in the target image, in the transitional image as an example, specifically, step S410 may be performed by the following Formulas (6) and (7):

x_dst0_0=[x_dst1/r2]−(m/2−1) Formula (6)

y_dst0_0=[y_dst1/r2]−(m/2−1) Formula (7)

where x_dst1 and y_dst1 denote coordinates of any one pixel in the target image, r2 denotes the second sub-rate, m denotes the number of the horizontal pixels or the vertical pixels of the second pixel block, and x_dst0_0 and y_dst0_0 denote coordinates of a first pixel in the transitional image block in the transitional image.

S411: determining an index of each target pixel in a second preset table according to the position of each target pixel in the target image, the second sub-rate, and a length of the second preset table LUT2.

Taking the determination of a corresponding weight of a certain pixel in the target image, in the second preset table as an example, specifically, step S411 may be performed by the following Formulas (8) and (9):

phase2_x=└x_dst1_0×len_1/r2┘−└x_dst1_0/r2┘×len_1 Formula (8)

phase2_y=└y_dst1_0×len_1/r2┘−└y_dst1_0/r2┘×len_1 Formula (9)

where x_dst1_0and y_dst1_0 denote coordinates of pixels in a first row and a first column of the target image, len_1 denotes the length of the second preset table, r2 denotes the second sub-rate, phase2_x and phase2_y denote indexes of the pixels in the first row and the first column of the target image, in the second preset table, and └ ┘ denotes rounding down.

S412: determining a weight corresponding to each pixel in the second pixel block from a second preset table according to the index of each target pixel in the second preset table.

S413: determining each transitional pixel block in the transitional image according to the position of the transitional image block, in the transitional image, corresponding to each target pixel and the number of the horizontal pixels or the vertical pixels of the second pixel block.

S414: correspondingly multiplying the pixel value of each pixel in each transitional pixel block by the horizontal weight and the vertical weight corresponding to each pixel in the second pixel block, and adding corresponding multiplied results to obtain the pixel value of each target pixel in the target image, to obtain the target image.

Taking determination of a certain pixel in the target image as an example, specifically, step S414 may be performed by the following Formula (10):

$$Formula ( 10 )$$

$$\begin{matrix}val\_dst 1 \_ 0 ( x\_dst 1 \_ 0 , y\_dst 1 \_ 0 ) = \\ params1\_ 0 \_x [ 0 ] \times params 1 \_ 0 \_y [ 0 ] \times val\_dst 0 ( x\_dst 0 , y\_dst 0 ) + \\ params1\_ 0 \_x [ 1 ] \times params1\_ 0 \_y [ 0 ] \times val\_dst 0 ( x\_dst 1 , y\_dst 0 ) + \\ params 1 \_ 0 \_x [ 2 ] \times params1\_ 0 \_y [ 0 ] \times val\_dst 0 ( x\_dst 2 , y\_dst 0 ) + \\ … \\ params 1 \_ 0 \_x [ 2 ] \times params1\_ 0 \_y [ 3 ] \times val\_dst 0 ( x\_dst 2 , y\_dst 3 ) + \\ params1\_ 0 \_x [ 3 ] \times params1\_ 0 \_y [ 3 ] \times val\_dst 0 ( x\_dst 3 , y\_dst 3 )\end{matrix}$$

where val_dst1_0(x_dst1_0, y_dst1_0) denotes a pixel value of a pixel whose coordinate is (x_dst1_0, y_dst1_0) in the target image, val_dst0(x_dst0, y_dst0) denotes a pixel value of a pixel whose coordinate is (x_dst0, y_dst0) in the transitional image, and params1_0_x[0] and params1_0_y[0] respectively denote weights corresponding to a first column of pixels and weights corresponding to a first row of pixels in the transitional image block, i.e., horizontal weights corresponding to a first column of pixels and vertical weights corresponding to a first row of pixels in the second pixel block.

In this way, the process of downsampling the transitional image at the second sub-rate to obtain the target image is completed. Finally, the original image is processed into the target image.

As can be seen from the above contents, in the method for processing the image provided by the embodiment of the present disclosure, the process of zooming out the original image is divided into the solution of two-stage downsampling, where high-frequency image information is retained in a first-stage downsampling and the final target resolution is reached in a second-stage downsampling, which may prevent part of the pixels in the original image from being not downsampled. Meanwhile, the way of dividing the downsampling rate and the principles to follow are limited, which may ensure that the downsampled image retains good texture information at a lower rate, and also ensure that the downsampled image retains good contour information at a higher rate. In addition, filtering operation is performed by means of the preset tables with different widths and the pixel blocks with different sizes in the two continuous stages, which may cause the two-stage filtering to be smoothly transitioned in the continuous change of a zoom-out rate. In this way, it may be ensured smooth transition of the textures of the original image in the continuous change of the rate.

Based on the same inventive concept, an embodiment of the present disclosure also provides a program for executing image processing by using a device for processing an image. The device for processing the image includes a data processing unit, and the program causes the data processing unit to: obtain an original image, downsample the original image at a first sub-rate to obtain a transitional image, and downsample the transitional image at a second sub-rate to obtain a target image. The first sub-rate and the second sub-rate are obtained by dividing a downsampling rate of the original image, and a product of the first sub-rate and the second sub-rate is equal to the downsampling rate.

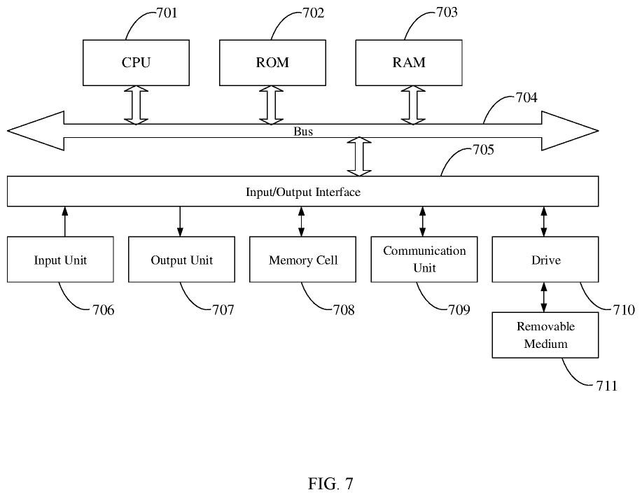

FIG. 7 is a schematic diagram showing hardware configuration of a device for processing an image according to an embodiment of the present disclosure. Referring to FIG. 7, the device for processing the image may include:

a central processing unit (CPU) 701 functions as a control unit or a data processing unit that executes various processing according to programs stored in a read only memory (ROM) 702 or a memory cell 708. For example, the CPU 701 executes processing according to the order described in the above embodiment. A random access memory (RAM) 703 stores therein programs executed by the CPU 701 and related data. The CPU 701, the ROM 702, and the RAM 703 are connected to each other via a bus 704.

The CPU 701 is connected to an input/output interface 705 via the bus 704, and the input/output interface 705 is connected to an input unit 706 including various switches, keyboards, mouse devices, microphones, sensors and other input components, and to an output unit 707 including a display, a speaker, and other output components.

The CPU 701 executes various processing in response to an instruction inputted from the input unit 706 and outputs a processing result to, for example, the output unit 707.

The memory cell 708 connected to the input/output interface 705 includes, for example, a hard disk or the like, and stores therein programs executed by the CPU 701 and various data. A communication unit 709 serves as a transmitting/receiving unit for Wi-Fi communication, Bluetooth (registered trademark) (BT) communication and any other data communication via a network such as the Internet or a local area network, and communicates with an external device.

A drive 310 connected to the input/output interface 705 drives a removable medium 311 including, for example, a magnetic disk, an optical disk and a magneto-optical disk, and a semiconductor memory such as a memory card to perform recording/reading of data.

It is pointed out here that the description of the above program embodiment is similar to the description of the above method or device embodiment and has similar beneficial effects as the method or device embodiment. Technical details not disclosed in the program embodiment of the present disclosure are understood with reference to the description of the method or device embodiment of the present disclosure.

The above-mentioned embodiments are merely specific embodiments of the present disclosure, but the protection scope of the present disclosure is not limited thereto. Any variation or substitution easily conceivable to a person of ordinary skills in the art within the technical scope disclosed in the present disclosure shall fall into the protection scope of the present disclosure. Therefore, the protection scope of the present disclosure shall be subject to the protection scope of the claims.

What is claimed is:

1. A device for processing an image, the device comprising:
a data processing unit configured to obtain an original image, to downsample the original image at a first sub-rate to obtain a transitional image, and to downsample the transitional image at a second sub-rate to obtain a target image;
wherein the first sub-rate and the second sub-rate are obtained by dividing a downsampling rate of the original image, and a product of the first sub-rate and the second sub-rate is equal to the downsampling rate.

2. The device according to claim 1, wherein the relationship between the first sub-rate and the second sub-rate is at least one of the following:
neither a reciprocal of the first sub-rate nor a reciprocal of the second sub-rate is an integer;
the first sub-rate is greater than the second sub-rate.

3. The device according to claim 1, wherein the data processing unit comprises:
a pixel block calculating unit configured to determine the number of horizontal pixels or vertical pixels of a first pixel block configured to be downsampled in the original image according to the first sub-rate, the number of the horizontal pixels or vertical the pixels of the first pixel block being greater than or equal to the reciprocal of the first sub-rate; and
an image sampling unit configured to downsample the original image on a basis of the first sub-rate and the number of the horizontal pixels or the vertical pixels of the first pixel block to obtain the transitional image.

4. The device according to claim 3, wherein the image sampling unit comprises:
a position calculating unit configured to determine, according to a position of each transitional pixel in the transitional image, the first sub-rate and the number of the horizontal pixels or the vertical pixels of the first pixel block, a position of an original pixel block, in the original image, corresponding to the each transitional pixel configured to be downsampled in the original image; and
a pixel calculating unit configured to calculate a pixel value of the each transitional pixel in the transitional image on a basis of the position of the original pixel block, in the original image, corresponding to the each transitional pixel and the number of the horizontal pixels or the vertical pixels of the first pixel block, to obtain the transitional image.

5. The device according to claim 3, wherein the image sampling unit comprises:
a weight determining unit configured to determine a weight corresponding to each pixel in the first pixel block;
a pixel block determining unit configured to determine each original pixel block in the original image according to the position of the original pixel block, in the transitional image, corresponding to the each transitional pixel in the original image and the number of the horizontal pixels or the vertical pixels of the first pixel block; and
a weighting unit configured to correspondingly multiply a pixel value of each pixel in each original pixel block by the weight corresponding to the each pixel in the first pixel block, and to add a corresponding multiplied result to obtain a pixel value of the each transitional pixel in the transitional image, to obtain the transitional image.

6. The device according to claim 5, wherein the weight determining unit comprises:
an index determining unit configured to determine, according to the position of the each transitional pixel in the transitional image, the first sub-rate and a length of a first preset table, an index of the each transitional pixel in a first preset table, wherein the first preset table stores a corresponding relationship between each index and a corresponding weight; and
a weight obtaining unit configured to determine the weight corresponding to the each pixel in the first pixel block from the first preset table according to the index of the each transitional pixel in the first preset table.

7. The device according to claim 5, wherein the position of the each transitional pixel in the transitional image comprises an abscissa and an ordinate, and the weight corresponding to the each pixel in the first pixel block comprises a horizontal weight and a vertical weight; and
the weighting unit is specifically configured to correspondingly multiply the pixel value of the each pixel in each original pixel block by the horizontal weight and the vertical weight corresponding to the each pixel in the first pixel block, and to add corresponding multiplied results to obtain the pixel value of the each transitional pixel in the transitional image.

8. A method for processing an image, performed by a device for processing an image, the method comprising:
obtaining an original image, downsampling the original image at a first sub-rate to obtain a transitional image, and downsampling the transitional image at a second sub-rate to obtain a target image;
wherein the first sub-rate and the second sub-rate are obtained by dividing a downsampling rate of the original image, and a product of the first sub-rate and the second sub-rate is equal to the downsampling rate.

9. The method according to claim 8, wherein the relationship between the first sub-rate and the second sub-rate is at least one of the following:
neither a reciprocal of the first sub-rate nor a reciprocal of the second sub-rate is an integer;
the first sub-rate is greater than the second sub-rate.

10. A program for executing image processing by using a device for processing an image, wherein the device for processing the image comprises a data processing unit, and the program causes the data processing unit to:
obtain an original image, downsample the original image at a first sub-rate to obtain a transitional image, and downsample the transitional image at a second sub-rate to obtain a target image;
wherein the first sub-rate and the second sub-rate are obtained by dividing a downsampling rate of the original image, and a product of the first sub-rate and the second sub-rate is equal to the downsampling rate.
